(19) United States
(12) Patent Application Publication
(10) Pub. No.: US 2026/0091775 A1
(43) Pub. Date: Apr. 2, 2026

(54) METHOD AND SYSTEM FOR LATERAL-VERTICAL COLLABORATIVE CONTROL OF DISTRIBUTED IN-WHEEL MOTOR DRIVE ELECTRIC VEHICLES

(71) Applicant: CHANG'AN UNIVERSITY, Xi'an (CN)

(72) Inventors: Xuan ZHAO, Xi'an (CN); Shu WANG, Xi'an (CN); Jia TIAN, Xi'an (CN); Jian MA, Xi'an (CN); Xiaolei YUAN, Xi'an (CN); Yilin HE, Xi'an (CN)

(21) Appl. No.: 19/413,283

(22) Filed: Dec. 9, 2025

Related U.S. Application Data
(63) Continuation of application No. PCT/CN2025/076455, filed on Feb. 8, 2025.

(30) Foreign Application Priority Data
Aug. 5, 2024 (CN) 202411066020.9

(51) Int. Cl. B60W 30/02; B60W 10/20; B60W 10/22; B60W 20/11; B60W 50/00

(52) U.S. Cl. CPC B60W 30/02; B60W 10/20; B60W 10/22; B60W 20/11; B60W 50/00; B60W 2050/0031; B60W 2520/14; B60W 2520/16; B60W 2520/18; B60W 2520/20; B60W 2540/18

(57) ABSTRACT

A method for lateral-vertical integrated control of a distributed in-wheel motor drive electric vehicle is provided, in which a fourteen-degree-of-freedom full-vehicle model is constructed based on an unbalanced magnetic force model of an in-wheel motor; a lateral force-tire slip angle-vertical load-based three-dimensional piecewise-affine tire model is constructed based on the fourteen-degree-of-freedom vehicle model in combination with a corrected Magic Formula tire model; an active front-wheel steering controller is established based on hybrid model predictive control using the three-dimensional piecewise-affine tire model; an active suspension system controller is established based on multi-constraint input and multi-constraint output; and an integrated control strategy for the active front-wheel steering controller and the active suspension system controller is established based on a front-wheel steering angle, a β-\dot{β} phase plane and a lateral load transfer rate. Related devices for implementing such method are also provided.

### CROSS-REFERENCE TO RELATED APPLICATIONS

This application is a continuation of International Patent Application No. PCT/CN2025/076455, filed on Feb. 8, 2025, which claims the benefit of priority from Chinese Patent Application No. 202411066020.9, filed on Aug. 5, 2024. The content of the aforementioned application, including any intervening amendments thereto, is incorporated herein by reference in its entirety.

### TECHNICAL FIELD

This application relates to vehicle control, and more particularly to a method and system for lateral-vertical integrated control of distributed in-wheel motor drive electric vehicles.

### BACKGROUND

Distributed drive electric vehicles (DDEVs), characterized by four-wheel independent drive and control, offer superior dynamic performance control and efficient energy transmission paths, thereby facilitating the implementation of more complex and reliable active safety control technologies.

In-wheel motor drive systems, as an emerging drive form for electric vehicles, simplify vehicle structures and improve transmission efficiency and driving stability, but simultaneously increase unsprung mass, thereby adversely affecting the lateral-vertical dynamic performance. It has been demonstrated that the vertical component of the unbalanced magnetic force generated by relative eccentricity between the stator and rotor couples with a suspension system, affecting the ride comfort and smoothness. Furthermore, the stator-rotor eccentricity is positively correlated with the unbalanced magnetic force, accelerating bearing wear and reducing motor service life. Additionally, such unbalanced magnetic force of the in-wheel motor will act directly on the tires, affecting tire-road contact performance and consequently weakening the handling stability. Under turning conditions, the body roll amplifies the stator-rotor eccentricity, intensifying unbalanced magnetic forces and further deteriorating the lateral dynamic performance. However, current lateral dynamics studies fail to consider this issue. Under the turning conditions, the body roll will induce load transfer, resulting in a significant coupling effect between lateral and vertical dynamics. However, most of the integrated lateral-vertical controller designs often adopt a linear tire model for lateral dynamics. Such controllers struggle to maintain stability when tires operate in nonlinear or saturated regions, and may even exacerbate the instability due to control decision errors under extreme conditions. Moreover, the tire lateral force depends not only on side-slip angle, but also on the vertical load and road adhesion coefficients.

In view of this, the existing in-wheel motor drive control strategies relying solely on linear lateral tire models under a single vertical load condition fail to accurately characterize the nonlinear characteristics of tires, resulting in poor control performance under extreme operating conditions.

### SUMMARY

An object of the disclosure is to provide a method and system for lateral-vertical integrated control of distributed in-wheel motor drive electric vehicles, so as to address the technical problems of poor control accuracy and effect in the stability control of existing distributed drive electric vehicles.

Technical solutions of the present disclosure are described as follows.

A method for lateral-vertical integrated control of a distributed in-wheel motor drive electric vehicle, comprising:
constructing a fourteen-degree-of-freedom (14-DOF) full-vehicle model based on an unbalanced magnetic force model of an in-wheel motor;
constructing a lateral force-tire slip angle-vertical load-based three-dimensional piecewise-affine tire model based on the 14-DOF full-vehicle model in combination with a corrected Magic Formula tire model;
based on the lateral force-tire slip angle-vertical load-based three-dimensional piecewise-affine tire model, establishing an active front-wheel steering controller based on hybrid model predictive control, and simultaneously establishing an active suspension system controller based on multi-constraint input and multi-constraint output with roll stability, ride comfort and stator-rotor eccentricity of the in-wheel motor as control objectives; and
establishing an integrated control strategy for the active front-wheel steering controller and the active suspension system controller based on a front-wheel steering angle, a β-\dot{β} phase plane and a lateral load transfer rate, so as to achieve lateral-vertical integrated control of the distributed in-wheel motor drive electric vehicle.

Compared to the prior art, the present disclosure has the following beneficial effects.

A method for lateral-vertical integrated control of distributed in-wheel motor drive electric vehicles is provided, in which the 14-DOF full-vehicle model based on the unbalanced magnetic force model of the in-wheel motor is established, such that vehicle state responses under different inputs are accurately represented. The lateral force-tire slip angle-vertical load-based three-dimensional piecewise-affine tire model is constructed, in which the lateral force of the tire under different side-slip angles and vertical loads is linearized in segments, such that nonlinear characteristics of the tire under extreme conditions are described. The active front-wheel steering (AFS) controller is established based on hybrid model predictive control, in which a reference center of mass side-slip angle and a reference yaw rate are obtained from a bicycle model, so as to calculate an additional steering angle and ensure the vehicle stability. The active suspension system (ASS) controller is designed with roll stability, ride comfort including dynamic tire load and vehicle body acceleration, and rotor-stator eccentricity of the in-wheel motor as control targets, and is implemented as a multi-constraint input/output active suspension system controller based on dual-model predictive control. The integrated control strategy is designed based on the front wheel steering angle, the β-\dot{β} phase plane, and the lateral load transfer rate, such that the active front-wheel steering controller and the active suspension system controller function in a complementary manner, thereby improving vehicle dynamic performance, achieving lateral-vertical integrated control of the distributed in-wheel motor drive electric vehicle, and enhancing overall vehicle stability and ride comfort.

Furthermore, the 14-DOF full-vehicle model includes longitudinal motion, lateral motion, yaw motion, pitch motion and roll motion, and vertical motions of sprung mass, stator mass and rotor-tire mass, thereby enabling a comprehensive analysis of the vehicle's dynamic responses under complex operating conditions and providing strong support for the design of the controllers.

In addition, the Magic Formula tire model is corrected in combination with the dynamics analysis of the wheel, the lateral force under different tire side-slip angles and vertical loads can be calculated more accurately, thereby improving the precision and reliability of the tire model.

### BRIEF DESCRIPTION OF THE DRAWINGS

FIG. 1 is a flowchart of a method for lateral-vertical integrated control of a distributed in-wheel motor drive electric vehicle according to an embodiment of the present disclosure;

FIG. 2 is a diagram of a lateral dynamics model according to an embodiment of the present disclosure;

FIG. 3 is a diagram of a vertical dynamics model according to an embodiment of the present disclosure;

FIG. 4 is a flowchart of an identification process for a three-dimensional piecewise-affine tire model according to an embodiment of the present disclosure;

FIG. 5 is a diagram of the three-dimensional piecewise-affine tire model according to an embodiment of the present disclosure;

FIG. 6 is a block diagram of an integrated active front-wheel steering (AFS)/active suspension (ASS) control system according to an embodiment of the present disclosure;

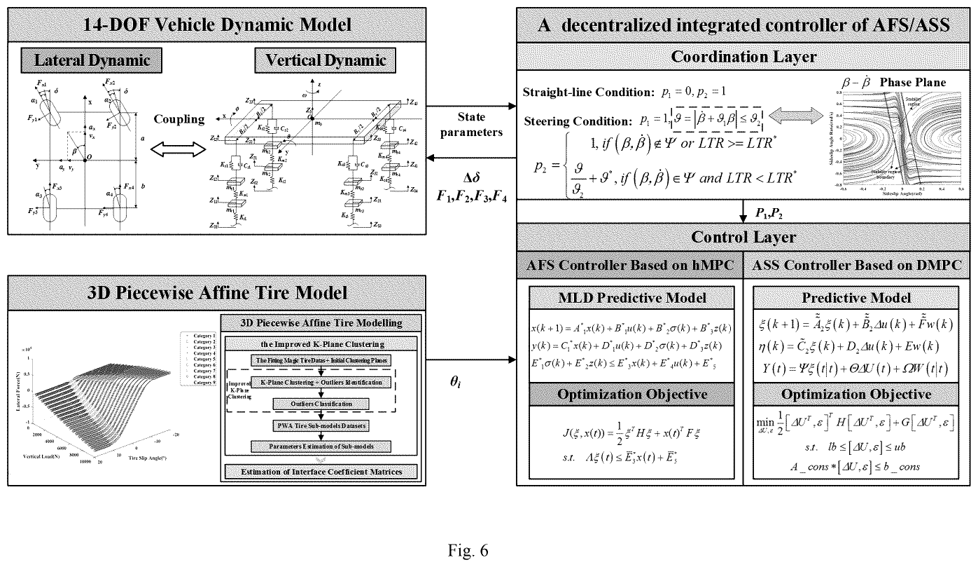

FIG. 7 is another flowchart of the method for lateral-vertical integrated control of the distributed in-wheel motor drive electric vehicle according to an embodiment of the present disclosure; and

FIG. 8 is a structural diagram of a system for lateral-vertical integrated control of a distributed in-wheel motor drive electric vehicle according to an embodiment of the present disclosure.

### DETAILED DESCRIPTION OF EMBODIMENTS

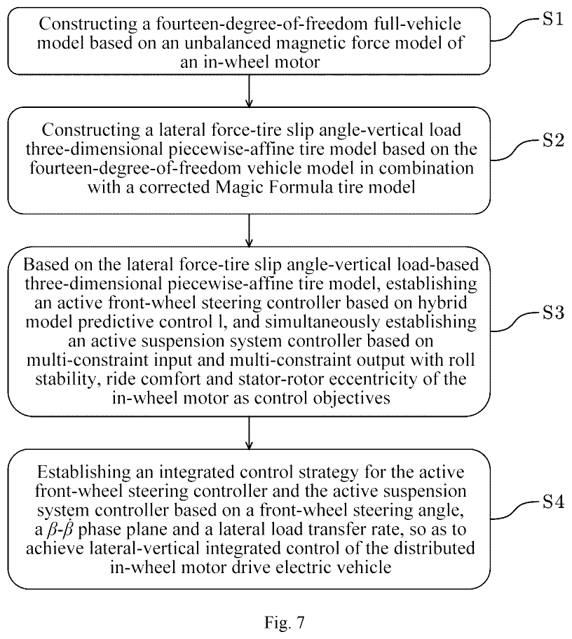

An embodiment of the present disclosure provides a method for lateral-vertical integrated control of a distributed in-wheel motor drive electric vehicle, as shown in FIG. 7, the method including the following steps.
(S1) A fourteen-degree-of-freedom (14-DOF) full-vehicle model is constructed based on an unbalanced magnetic force model of an in-wheel motor.
(S2) A lateral force-tire slip angle-vertical load-based three-dimensional piecewise-affine tire model is constructed based on the 14-DOF full-vehicle model in combination with a corrected Magic Formula tire model.
(S3) Based on the lateral force-tire slip angle-vertical load-based three-dimensional piecewise-affine tire model, an active front-wheel steering controller based on hybrid model predictive control is established, and an active suspension system controller based on multi-constraint input and multi-constraint output is simultaneously established with roll stability, ride comfort and stator-rotor eccentricity of the in-wheel motor as control objectives.
(S4) An integrated control strategy of the active front-wheel steering controller and the active suspension system controller is constructed based on a front-wheel steering angle, a β-\dot{β} phase plane and a lateral load transfer ratio, so as to achieve lateral-vertical integrated control of the distributed in-wheel motor drive electric vehicle.

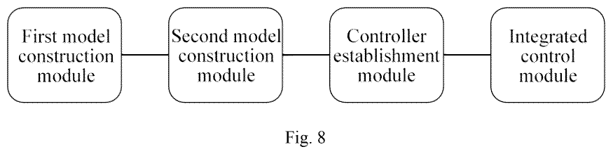

As shown in FIG. 8, the present disclosure also provides a system for lateral-vertical integrated control of a distributed in-wheel motor drive electric vehicle, including a first model construction module, a second model construction module, a controller establishment module and an integrated control module. The first model construction module is configured to construct the 14-DOF full-vehicle model based on the unbalanced magnetic force model of the in-wheel motor. The second model construction module is configured to construct the lateral force-tire slip angle-vertical load-based three-dimensional piecewise-affine tire model based on the 14-DOF full-vehicle model in combination with the corrected Magic Formula tire model. The controller establishment module is configured to establish the active front-wheel steering controller based on hybrid model predictive control using the three-dimensional piecewise-affine tire model, and simultaneously establish the active suspension system controller based on multi-constraint input and multi-constraint output with roll stability, ride comfort, and stator-rotor eccentricity of the in-wheel motor as the control objectives. The integrated control module is configured to establish an integrated control strategy for the active front-wheel steering controller and the active suspension system controller based on the front-wheel steering angle, the β-β phase plane and the lateral load transfer rate, so as to achieve lateral-vertical integrated control of the distributed in-wheel drive electric vehicle.

The present disclosure further provides a device, including a memory and a processor. The memory is configured to store a computer program. The processor is configured to execute the computer program to implement the method described above.

The processor is configured to execute the computer program to implement the steps of the method described above, including, for example:
constructing the 14-DOF full-vehicle model based on the unbalanced magnetic force model of the in-wheel motor;
constructing the lateral force-tire slip angle-vertical load-based three-dimensional piecewise-affine tire model based on the 14-DOF full-vehicle model in combination with the corrected Magic Formula tire model;
based on the lateral force-tire slip angle-vertical load-based three-dimensional piecewise-affine tire model, establishing the active front-wheel steering controller based on hybrid model predictive control, and simultaneously establishing the active suspension system controller based on multi-constraint input and multi-constraint output with roll stability, ride comfort and stator-rotor eccentricity of the in-wheel motor as control objectives; and
establishing the integrated control strategy for the active front-wheel steering controller and the active suspension system controller based on the front-wheel steering angle, the β-\dot{β} phase plane and the lateral load transfer ratio, so as to achieve lateral-vertical integrated control of the distributed in-wheel motor drive electric vehicle.

In some embodiments, the computer program may be divided into one or more modules/units, which are stored in the memory and executed by the processor to implement the method provided herein. The one or more modules/units may be a series of segments of computer program instructions configured to perform a predetermined function, and the segments are used to describe an execution process of the computer program in the device described herein. For example, the computer program may be divided into the first model construction module, the second model construction module, the controller establishment module and the integrated control module.

The device provided herein may be a computing device such as a desktop computer, a notebook computer, a handheld computer or a cloud server. The device may include, but is not limited to, a processor and a memory. It should be understood by those skilled in the art that the device described above is merely illustrative, and are not intended to limit the scope of the present disclosure. The device may include more components than those described above, or may combine certain components, or may include different components. For example, the device may further include an input device, an output device, a network access device and a bus.

The processor may be a central processing unit (CPU), or may be another general-purpose processor, a digital signal processor (DSP), an application-specific integrated circuit (ASIC), a field-programmable gate array (FPGA), or other programmable logic devices, discrete gate or transistor logic devices and discrete hardware components. The general-purpose processor may be a microprocessor, or the processor may be any conventional processor. The processor serves as a control center of the device provided herein, and is configured for connecting various parts of the device provided herein through various interfaces and lines.

The memory is configured to store the computer program and/or modules. The processor is configured to implement various functions of the device by running or executing the computer program and/or modules stored in the memory and accessing data stored in the memory.

The memory may primarily include a program storage area and a data storage area. The program storage area may store an operating system and application programs required for at least one function (such as a sound playback function and an image playback function). The data storage area may store data created based on the use of a mobile phone (such as audio data and a phonebook). In addition, the memory may include a high-speed random-access memory, a non-volatile memory, such as a hard disk, a memory, a plug-in hard disk, a Smart Media Card (SMC), a Secure Digital (SD) card, a Flash Card, at least one disk storage device, a flash memory device, or other volatile solid-state memory devices.

The present disclosure also provides a computer-readable storage medium configured for storing a computer program. The computer program is configured to be executed by a processor to implement the method provided herein.

In a case where the modules/units integrated in the system are implemented as software functional units and intended for sale or use as standalone products, the modules/units can be stored on a computer-readable storage medium.

Based on such an understanding, all or part of the processes in the above-described method can be implemented by instructing relevant hardware through a computer program. The computer program can be stored on a computer-readable storage medium. When executed by a processor, the computer program is configured to implement the steps of the above-described method. The computer program includes computer program codes, which can be in the form of source code, object code, executable file or a predetermined intermediate form.

The computer-readable storage medium may include any entity or device capable of carrying the computer program code, such as a recording medium, a USB flash drive, a portable hard drive, a disk, an optical disc, a computer memory, Read-Only Memory (ROM), Random Access Memory (RAM), an electrical carrier signal, a telecommunication signal and a software distribution medium.

It should be noted that the contents included in the computer-readable storage medium may be appropriately increased or reduced in accordance with the requirements of legislation and patent practice in different jurisdictions. For example, in certain jurisdictions, under applicable legislation and patent practice, the computer-readable storage medium may not include electrical carrier signals and telecommunication signals.

The present disclosure will be further described with reference to the embodiments and accompanying drawings.

### Example 1

The present disclosure provides a method for lateral-vertical integrated control of a distributed in-wheel motor drive electric vehicle. The method provided herein can address the technical problems in the prior art associated with the effects of unbalanced magnetic forces on the suspension and tires, as well as the limited modeling and control accuracy of the lateral controller due to linear tire assumptions.

As used herein, the following terms are defined as follows: AFS is an active front-wheel steering system, ASS is an active suspension system, PWA denotes piecewise affine, hMPC denotes hybrid model predictive control and DMPC denotes dual model predictive control.

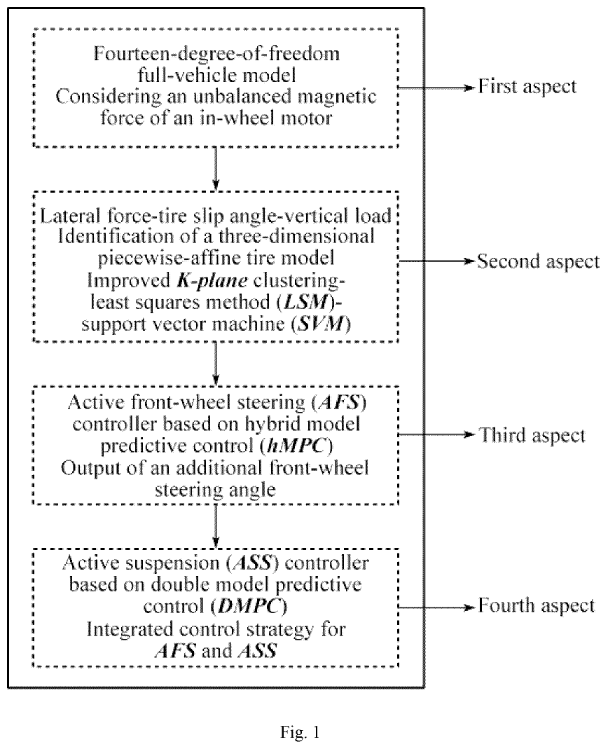

As shown in FIG. 1, the present embodiment provides a method for lateral-vertical integrated control of a distributed in-wheel motor drive electric vehicle, including four aspects. The method includes the following steps.

In a first aspect, a fourteen-degree-of-freedom (14-DOF) full-vehicle model is constructed based on an unbalanced magnetic force model of an in-wheel motor.

Step (1) A stator is separated from a rotor, and the rotor is integrated with the tire. The 14-DOF full-vehicle model includes longitudinal motion, lateral motion, yaw motion, pitch motion and roll motion, and vertical motions of sprung mass, stator mass and rotor-tire mass.

Differential equations of the longitudinal motion and the lateral motion are respectively expressed as:

$${ma}_{x} = {F}_{x 1} cos ( δ ) + {F}_{x 2} cos ( δ ) + {F}_{x 3} + {F}_{x 4} ; and$$

$${ma}_{y} = {F}_{y 1} cos ( δ ) + {F}_{y 2} cos ( δ ) + {F}_{y 3} + {F}_{y 4} .$$

In the above equations, m is a vehicle mass, δ is a front-wheel steering angle, aₓ is a longitudinal acceleration, expressed as aₓ=\dot{v}ₓ−v_{y}ω, a_{y} is a lateral acceleration, expressed as a_{y}=\dot{v}_{y}+vₓω, vₓ is a longitudinal velocity, v_{y} is a lateral velocity, Fₓᵢ is a wheel longitudinal force, and F_{yi} is a wheel lateral force, and i=1, 2, 3 and 4 representing a left-front tire, a right-front tire, a left-rear tire and a right-rear tire, respectively. The following equations are expressed in a similar manner.

Differential equations of the yaw motion, the pitch motion and the roll motion are respectively expressed as:

$${I}_{z} \dot{ω} = a ( {F}_{y 1} + {F}_{y 2} ) cos ( δ ) - b ( {F}_{y 3} + {F}_{y 4} ) + \frac{{B}_{r}}{2} ( {F}_{x 2} cos ( δ ) + {F}_{x 4} ) - \frac{{B}_{f}}{2} ( {F}_{x 1} cos ( δ ) + {F}_{x 3} ) ;$$

$${I}_{y} \ddot{θ} = b ( {F}_{s 3} + {F}_{s 4} ) - a ( {F}_{s 1} + {F}_{s 2} ) + {m}_{b} g ( {h}_{g} - {h}_{s} ) θ ; and$$

$${I}_{x} \ddot{ϕ} = \frac{{B}_{f}}{2} ( {F}_{s 1} - {F}_{s 2} ) + \frac{{B}_{r}}{2} ( {F}_{s 3} - {F}_{s 4} ) + {m}_{b} g ( {h}_{g} - {h}_{s} ) ϕ + {m}_{b} {a}_{y} ( {h}_{g} - {h}_{s} ) .$$

In the above equations, ω is a yaw rate, a represents a distance between a center of mass and a front axle, b denotes a distance between the center of mass and a rear axle; B_{f} and Bᵣ denote front and rear track widths, respectively; θ is a pitch angle, h_{g} is a height from the center of mass to ground, hₛ is a height from a roll center to the ground, g is a gravitational acceleration, Fₛᵢ is a suspension force, mb is the sprung mass, φ is a roll angle, Iₓ represents a moment of inertia about an x-axis of a coordinate system of the distributed in-wheel motor drive electric vehicle, I_{y} represents a moment of inertia about a y-axis of the coordinate system of the distributed in-wheel motor drive electric vehicle, and I_{z} denotes a moment of inertia about a z-axis of the coordinate system of the distributed in-wheel motor drive electric vehicle.

The vertical motions of the sprung mass, the stator mass, and the rotor-tire mass are respectively expressed as:

$${m}_{b} {\ddot{Z}}_{b} = {F}_{s 1} + {F}_{s 2} + {F}_{s 3} + {F}_{s 4} ;$$

$${m}_{s} , {\ddot{Z}}_{2} = {K}_{mi} ( {Z}_{i 1} - {Z}_{i 2} ) - {K}_{si} ( {Z}_{i 2} - {Z}_{i 3} ) - {C}_{si} ( {\dot{Z}}_{i 2} - {\dot{Z}}_{i 3} ) - {F}_{si} + {F}_{Ei} ; and$$

$${m}_{ri} {\ddot{Z}}_{i 1} = {K}_{ti} ( {Z}_{0 i} - {Z}_{i 1} ) - {K}_{mi} ( {Z}_{i 1} - {Z}_{i 2} ) - {F}_{Ei} .$$

In the above equations, Fₛᵢ=Kₛᵢ(Zᵢ₂−Zᵢ₃)+Cₛᵢ(Żᵢ₂−Żᵢ₃)+Fᵢ, mₛᵢ is the stator mass, mᵣᵢ is the rotor-tire mass, Kₛᵢ is a suspension stiffness coefficient, Cₛᵢ is a suspension damping coefficient, Kₘᵢ is a stiffness coefficient between the stator and the rotor of the in-wheel motor, Kₜᵢ is a tire stiffness coefficient, Zᵢ₁ denotes a vertical displacement of the tire and the rotor, Zᵢ₂ denotes a vertical displacement of the stator, Zᵢ₃ denotes a vertical displacement of the sprung mass, Z₀ᵢ denotes a four-wheel road roughness, Fᵢ denotes a suspension actuating force, and F_{Ei} denotes a vertical unbalanced excitation of the in-wheel motor.

Step (2) The corrected Magic Formula tire model is obtained by introducing a road adhesion coefficient into a Magic Formula tire model, and is expressed as:

$${F}_{y} = μ {D}_{y} sin \{ \frac{5 - μ}{4} {C}_{y} arctan [ ( 2 - μ ) {B}_{y} α ( 1 - {E}_{y} ) + {E}_{y} arctan ( ( 2 - μ ) {B}_{y} α ) ] \} .$$

In the above equations, F_{y} is a wheel lateral force, μ is the road adhesion coefficient, α is a tire side-slip angle, B_{y} is a stiffness factor, C_{y} is a shape factor, D_{y} is a crest factor and E_{y} is a curvature factor.

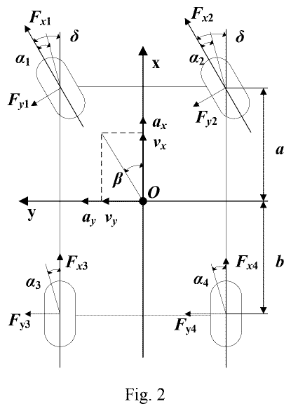

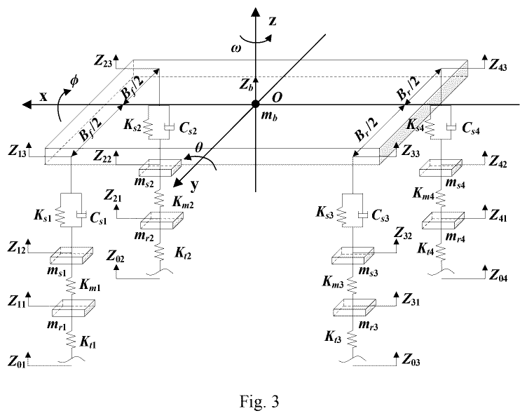

The 14-DOF full-vehicle model is illustrated in FIGS. 2-3.

In a second aspect, the lateral force-tire slip angle-vertical load-based three-dimensional piecewise-affine tire model is constructed through the following steps.

An original dataset Ω is constructed based on lateral force-tire slip angle-vertical load data obtained by the corrected Magic Formula tire model. Clustering is performed on the original dataset Ω using an improved K-plane clustering algorithm. The clustering is performed through the following steps.

Step (1) The original dataset Ω is uniformly divided into n×m sub-datasets Ωⱼ, (j=1 . . . n×m) along an x-axis and a y-axis of three-dimensional scatter plot constructed from extracted data. A plane parameter of each of the n×m sub-datasets Ωⱼ is fitted using a least squares estimation method, expressed as:

$$min {\sum }_{( \tilde{x} ( k ) , \tilde{z} ( k ) ∈ {Ω}_{j} )} {‖ {ε}_{j}^{T} [ \begin{matrix}\tilde{x} ( k ) \\ 1\end{matrix} ] - \tilde{z} ( k ) ‖}^{2} .$$

In the above equations,

$${ε}_{j}^{T} = [ {a}_{j} , {b}_{j} , {c}_{j} , {d}_{j} ]$$

denotes the plane parameter of each of the n×m sub-datasets Ωⱼ.

Under the assumption that there are p initial clustering planes, one of the p initial clustering planes is randomly selected as a first initial plane, which is denoted as:

$${M}_{1} = \{ {a}_{1} , {b}_{1} , {c}_{1} , {d}_{1} \} .$$

Step (2) Plane identification is performed on the n×m sub-datasets Ωⱼ, and q initial planes are randomly selected from n×m sub-planes. A parameter mean of determined initial planes {M₁, M₂ . . . , M_{q}} is denoted as M̅={ā,b̅,c̅,d̅}. A difference between a parameter of each of remaining planes among the p initial clustering planes and the parameter mean M̅ is calculated by using Euclidean distance, expressed as: Dᵢ(Ωⱼ, Mᵢ) An initial clustering plane with a maximum difference max Dᵢ(Ωⱼ, Mᵢ) is selected as a second initial plane.

Step (3) Step (2) is repeated until p initial planes {M₁,M₂, . . . , Mₚ} have been selected.

The above steps are carried out to complete the initialization of the K-plane clustering.

Step (4) Clustering is performed on tire data point using the p initial planes, so as to obtain p data subsets {J₁, J₂, . . . , Jₚ}. A tire data point (xᵢ, yᵢ, zᵢ) is assigned to a nearest plane Jⱼ. A data classification rule is expressed as if min(Disᵢ₋ⱼ)⇔(xᵢ, yᵢ, zᵢ)∈Jⱼ.

In the above formula, Disi-j denotes a distance between the tire data point (xᵢ, yᵢ, zᵢ) and a j-th initial plane.

Step (5) Identification and secondary classification of boundary outliers are performed. When the number of planes for which a distance between the tire data point (xᵢ, yᵢ, zᵢ) and a plane is less than a certain threshold is greater than or equal to 2, the tire data point (xᵢ, yᵢ, zᵢ) is considered as a boundary outlier, and the following condition is satisfied:

$$A = [ {Dis}_{i - 1} , {Dis}_{i - 2} , … , {Dis}_{i - p} ]$$

$$num ( A ( i ) \leq {ε}_{boundary} ) \geq 2.$$

In the above formula, A denotes a distance between the tire data point (xᵢ, yᵢ, zᵢ) and each of planes obtained through re-selection and assignment of data as performed in steps (3) and (4), and E boundary is a boundary outlier threshold.

The boundary outliers are classified based on minimization of a distance between each of the boundary outliers and a center of each of the p data subsets, so as to obtain a three-dimensional piecewise-affine tire sub-model dataset {PĴ₁,PĴ₂, . . . , PĴₚ}.

Step (6) A parameter of each of the p data subsets is re-identified using the LSM, and steps 4-5 (data classification, boundary outlier identification and reclassification) are repeated, so as to obtain the three-dimensional piecewise-affine model through multiple iterative cycles of K-plane clustering.

Step (7) Intersecting outliers are identified and reclassified through the following steps. A data subset PĴₑ containing the intersecting outliers is projected onto the x-axis, the y-axis, or the z-axis, so as to convert the data subset PĴₑ into one-dimensional data. K-means clustering analysis is performed on the one-dimensional data to obtain a plurality of clustered sub-datasets. The intersecting outliers are identified based on proportion of each of the plurality of clustered sub-datasets within the data subset PĴₑ, where the proportion of each of the plurality of clustered sub-datasets is expressed as:

$$\frac{size ( P {\hat{J}}_{e \vert j} )}{size ( P {\hat{J}}_{e} )} \leq {ξ}_{cut} .$$

In the above equation, PĴ_{e|j} is a sub-dataset obtained by k-means clustering, e=1, 2, . . . , p, and j denotes the number of clusters generated by the k-means clustering, which is determined by distribution of PĴₑ, size (*) denotes the number of data points in the data subset PĴₑ, and ξ_{cut} is a segmentation outlier threshold.

The intersecting outliers is classified based on minimization of a distance between each of the intersecting outliers and the center of each of the p data subsets, so as to obtain the three-dimensional piecewise-affine tire sub-model {P\tilde{J}₁,P\tilde{J}₂, . . . , P\tilde{J}ₚ}, a plane parameter of the three-dimensional piecewise-affine tire sub-model {P\tilde{J}₁,P\tilde{J}₂, . . . , P\tilde{J}ₚ} is re-identified using the LSM.

Step (8) A boundary coefficient matrix of the three-dimensional piecewise-affine tire sub-model is estimated using a support vector machine, including the following steps.

First, two adjacent data subsets are identified, satisfying

$$\{ P {\hat{J}}_{i} , P {\hat{J}}_{j} \} = {min}_{i \neq j , 1 \leq i , j \leq s} \{ {m}_{i} , {m}_{j} \} ,$$

where mᵢ is a center of data subset PĴᵢ, mⱼ is a center of data subset PĴⱼ. Data points of the two adjacent data subsets are taken as input data and denoted as X={X₁,X₂, . . . X_{N}}. Each sample of the input data is composed of multiple features, so as to form a feature space Xᵢ={x₁,x₂, . . . , xₙ}. Given a learning target y={y₁, y₂, . . . y_{N}}, samples in the data subset PĴᵢ are assigned a label y(i)=1, representing a positive class, and samples in the data subset PĴⱼ are assigned a label y(j)=−1, representing a negative class. In order to prevent the existence of linearly inseparable data, a slack variable ν is introduced, and a convex quadratic programming problem is formulated as:

$${min}_{α} \frac{1}{2} {\sum }_{i = 1}^{N} {\sum }_{j = 1}^{N} {α}_{i} {α}_{j} {y}_{i} {y}_{j} κ ( {X}_{i} \cdot {X}_{j} ) - {\sum }_{i = 1}^{N} {α}_{i}$$

$$s . t . {\sum }_{i = 1}^{N} {α}_{i} {y}_{i} = 0$$

$$0 \leq {α}_{i} \leq υ , i = 1 , 2 , … N .$$

In the above formula, denotes a Lagrange multiplier, and αᵢ≥0 κ(*·*) is a kernel function, and Nis the number of samples in a training dataset.

The three-dimensional piecewise-affine tire model is expressed as:

$${F}_{y} = {θ}_{i - 1} , α + {θ}_{i - 2} {F}_{z} + {θ}_{i - 3} , i = ( 1 , 2 , … , p ) .$$

In the above formula, θᵢ₋₁, θᵢ₋₂ and θᵢ₋₃ denotes parameters of the three-dimensional piecewise-affine tire model.

It should be noted that in conventional K-plane clustering, each data point is clustered based on the minimum distance to a plane. However, when a data point is close to multiple planes, clustering solely based on distance may generate boundary outliers, i.e., inseparable data points. In addition, the planes obtained from the K-plane clustering extend infinitely, which may result in multiple planes intersecting each other in three-dimensional space, thereby producing intersecting outliers. Therefore, these two types of outliers need to be separately identified and reclassified.

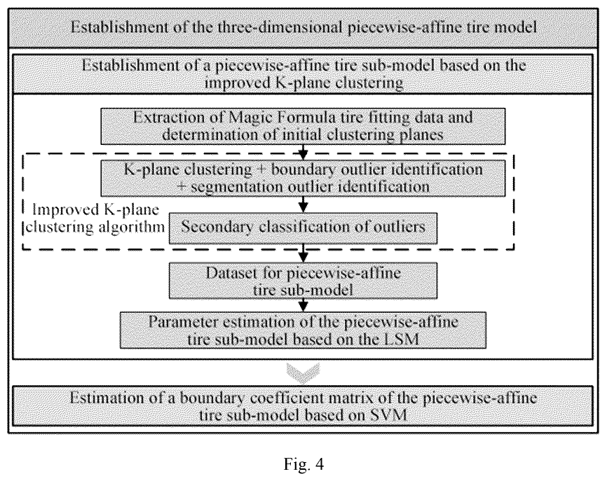

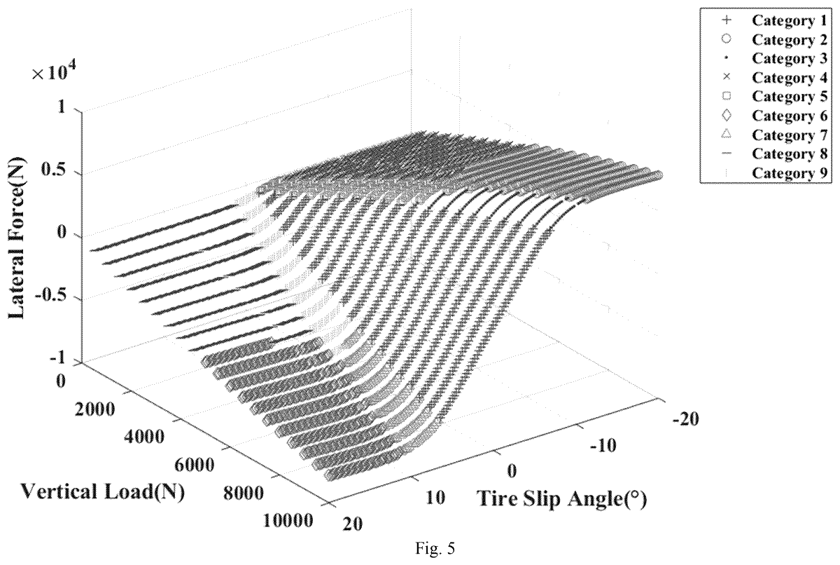

The three-dimensional piecewise-affine process of the corrected Magic Formula tire model according to this embodiment is shown in FIG. 4. and the affine results are shown in FIG. 5. It can be seen that the three-dimensional surface is divided into nine linear planes.

In a third aspect, an active front-wheel steering controller based on hybrid model predictive control (hMPC) is established based on the lateral force-tire slip angle-vertical load-based three-dimensional piecewise-affine tire model.

Step (1) Based on the 14-DOF full-vehicle model, a lateral dynamics model is simplified under the assumptions that the front-wheel steering angle is small and longitudinal forces on all four wheels are equal, and is expressed as:

$$\sum {F}_{Y} = {F}_{y 1} + {F}_{y 2} + {F}_{y 3} + {F}_{y 4}$$

$$\sum {M}_{z} = a ( {F}_{y 1} + {F}_{y 2} ) - b ( {F}_{y 3} + {F}_{y 4} ) .$$

Let x=[Δβ,Δω]^{T} be defined as a state vector, y=[Δβ, Δω]^{T} as an output, and u=Δδ_{f} as an input, where Δω=ω−ω_{d} and Δβ=β−β_{d}, Δδ_{f} is an additional active front-wheel steering angle, and ω_{d} and β_{d} are ideal state parameters. An error state-space equation is obtained and expressed as:

$$\{ \begin{matrix}x ( k + 1 ) = {A}_{l r} x ( k ) + {B}_{l r} u ( k ) + {f}_{l r} \\ y ( k + 1 ) = {C}_{1} x ( k ) + {D}_{1} u ( k ) + {g}_{l r}\end{matrix} .$$

In the above equation, l denotes a PWA tire sub-model corresponding to the left-front tire, r denotes a PWA tire sub-model corresponding to the right-front tire and l=(1, 2, . . . , p) r=(1, 2, . . . , p) and Aₗᵣ, Bₗᵣ, fₗᵣ, C₁, D₁, gₗᵣ are coefficient matrices of the error state-space equation, expressed as:

$${A}_{lr} = [ \begin{matrix}\frac{{θ}_{l - i - 1} + {θ}_{r - i - 1} + 2 {K}_{r}}{mu} & \frac{a ( {θ}_{l - i - 1} + {θ}_{r - i - 1} ) - 2 {bK}_{r}}{{mu}^{2}} - 1 \\ \frac{a ( {θ}_{l - i - 1} + {θ}_{r - i - 1} ) - 2 {bK}_{r}}{{I}_{z}} & \frac{a ( {θ}_{l - i - 1} + {θ}_{r - i - 1} ) + 2 {b}^{2} {K}_{r}}{{I}_{z} u}\end{matrix} ] ,$$

$${B}_{lr} = [ \begin{matrix}- \frac{{θ}_{l - i - 1} + {θ}_{r - i - l}}{mu} \\ - \frac{a ( {θ}_{l - i - 1} + {θ}_{r - i - 1} )}{{I}_{z}}\end{matrix} ]$$

$${f}_{lr} = [ \begin{matrix}\frac{{θ}_{l - i - 3} + {θ}_{r - i - 3} + {θ}_{l - i - 2} {F}_{z 1} + {θ}_{r - i - 2} {F}_{z 2}}{mu} \\ \frac{a ( {θ}_{l - i - 3} + {θ}_{r - i - 3} + {θ}_{l - i - 2} {F}_{z 1} + {θ}_{r - i - 2} {F}_{z 2}}{{I}_{z}}\end{matrix} ] ,$$

$${C}_{1} = [ \begin{matrix}1 & 0 \\ 0 & 1\end{matrix} ] ,$$

$${D}_{1} = [ \begin{matrix}0 \\ 0\end{matrix} ] ,$$

$${g}_{lr} = [ \begin{matrix}0 \\ 0\end{matrix} ] .$$

In the above equation, θₗ₋ᵢ₋ₘ denotes a parameter of the PWA tire sub-model corresponding to the left tire, and θᵣ₋ᵢ₋ₘ denotes a parameter of the PWA tire sub-model corresponding to the right tire, and i=(1, 2, . . . , p), m=(1,2,3), and Kᵣ is cornering stiffnesses of the left-rear and right-rear tires.

Step (2) An auxiliary discrete variable σₙ∈={0, 1}, n=(1, 2, . . . , p²) is introduced, and the error state-space equation is transformed based on the auxiliary discrete variable in combination with IF-THEN-ELSE rules, expressed as:

$$\{ \begin{matrix}{x}_{1} ( k + 1 ) = \{ \begin{matrix}{A}_{1} x ( k ) + {B}_{1} u ( k ) + {f}_{1} , & if ( {σ}_{1} ( k ) = 1 ) \\ 0 , & otherwise\end{matrix} \\ {x}_{{p}^{2}} ( k + 1 ) = \{ \begin{matrix}{A}_{{p}^{2}} x ( k ) + {B}_{{p}^{2}} u ( k ) + {f}_{{p}^{2}} , & if ( {σ}_{{p}^{2}} ( k ) = 1 ) \\ 0 , & otherwise\end{matrix} \\ {\sum }_{n = 1}^{{p}^{2}} {σ}_{n} ( k ) = 1 , {σ}_{i} ( k ) ⋂ {σ}_{j} ( k ) = ∅ , ∀ i \neq j\end{matrix} .$$

The above equation indicates that, when the system enters a n-th control region, it is considered equivalent to σₙ=1; otherwise, it is considered as σₙ=0.

Accordingly, a continuous auxiliary variable zₙ(k)=[Aₙx(k)+Bₙu(k)+fₙ]·σₙ(k) is introduced, and a mixed logical dynamical (MLD) predictive model is expressed as:

$$x ( k + 1 ) = {A}_{1}^{*} x ( k ) + {B}_{1}^{*} u ( k ) + {B}_{2}^{*} σ ( k ) + {B}_{3}^{*} z ( k )$$

$$y ( k ) = {C}_{1}^{*} x ( k ) + {D}_{1}^{*} u ( k ) + {D}_{2}^{*} σ ( k ) + {D}_{3}^{*} z ( k )$$

$${E}_{1}^{*} σ ( k ) + {E}_{2}^{*} z ( k ) \leq {E}_{3}^{*} x ( k ) + {E}_{4}^{*} u ( k ) + {E}_{5}^{*} .$$

Step (3) An optimized objective function is expressed as:

$$J ( ξ ( t ) , u ( t - 1 ) , Δ U ( t ) ) = {\sum }_{i = 1}^{{N}_{p}} {‖ y ( t + i \vert t ) ‖}_{Q}^{2} + {\sum }_{i = 1}^{{N}_{c} - 1} {‖ Δ u ( t + i \vert t ) ‖}_{R}^{2} .$$

In the above equation, Nₚ is a prediction horizon, and N_{c} is a control horizon.

The following quadratic programming problem is solved to obtain the additional steering angle:

$$J ( ξ , x ( t ) ) = \frac{1}{2} {ξ}^{T} H ξ + {x ( t )}^{T} F ξ$$

$$s . t . Λξ ( t ) \leq {\overline{E}}_{3}^{*} x ( t ) + {\overline{E}}_{5}^{*} .$$

In the above equation, ξ(t)=[U(t) Δ(t) Z(t)]^{T}, U(t), Δ(t) and Z(t) denote sequences of a system output, a control variable, and an auxiliary discrete variable and an continuous auxiliary variable within the prediction horizon, respectively; matrices Λ, H, F, Ē*₃ and Ē*₅ are coefficient matrices recursively obtained based on the solution of the MLD predictive model.

It should be noted that, during the design of the AFS controller, in order to prevent an excessive increase in computational load and a resulting slowdown in controller response due to overly complex hybrid logic, only the left-front and right-front tires are modeled using the PWA tire model, while the left-rear and right-rear tires are modeled using conventional linear models.

In a fourth aspect, taking roll stability, ride comfort and stator-rotor eccentricity of the in-wheel motor as control objectives, an active suspension system controller based on multi-constraint input and multi-constraint output is established using dual-model predictive control (DMPC). An integrated control strategy for the active front-wheel steering controller and the active suspension system controller is established.

Step (1) A 14-DOF full-vehicle vertical model is simplified into a six-degree-of-freedom left-right half-vehicle suspension model, and its state-space equation is expressed as:

$$\dot{x} = {A}_{2} x + {B}_{2} u + Fw$$

$${y}_{roll} = {C}_{2} x + {D}_{2} u + Ew$$

$${y}_{comfort} = {C}_{2}^{*} x + {D}_{2}^{*} u + {E}^{*} w .$$

In the above equation, a state variable denotes x=[\dot{φ}, Ż_{b}, Żₛ₁, Żₛ₂, Żᵣ₁, Żᵣ₂, φ, Z_{b}, Zₛ₁, Zₛ₂, Zᵣ₁, Zᵣ₂]; a system input denotes u=[F1, F2], i.e., the active force output by the active suspension system. The unbalanced magnetic force and road roughness are regarded as an external disturbance, and denoted as w=[FE1, FE2, Z₀₁, Z₀₂], a system output denotes yᵣₒₗₗ=[φ], i.e., the roll angle, and y_{comfort}=[Zᵣ₁−Zₛ₁, Zᵣ₂−Zₛ₂, Z₀₁−Z₀₁, Z₀₂−Zᵣ₂, \ddot{Z}_{b}], i.e., eccentricities between the stators and rotors of the left and right in-wheel motors, dynamic tire loads, and vehicle body acceleration.

Step (2) Here, the derivation of the MPC controller for roll stability is taken as an example (the derivation for ride comfort is analogous), and the following is defined:

$$ξ ( k \vert t ) = [ \begin{matrix}x ( k \vert t ) \\ u ( k - 1 \vert t )\end{matrix} ] .$$

The above state-space equation is discretized using a forward Euler method to obtain the following discrete-time state-space equation:

$$ξ ( k + 1 ) = {\tilde{\tilde{A}}}_{2} ξ ( k ) + {\tilde{\tilde{B}}}_{2} Δ u ( k ) + \tilde{\tilde{F}} w ( k )$$

$$η ( k ) = {\tilde{C}}_{2} ξ ( k ) + {D}_{2} Δ u ( k ) + Ew ( k ) .$$

The matrix expressions in the equation are given as:

$${\tilde{\tilde{A}}}_{2} = ∼ [ \begin{matrix}{\tilde{A}}_{2} & {\tilde{B}}_{2} \\ {O}_{Nu \times Nx} & {I}_{Nu}\end{matrix} ] , {\tilde{\tilde{B}}}_{2} = \approx [ \begin{matrix}{\tilde{B}}_{2} \\ {I}_{Nu}\end{matrix} ] , \tilde{\tilde{F}} = \approx [ \begin{matrix}F \\ {O}_{Nu \times Nz}\end{matrix} ] and$$

$${\tilde{C}}_{2} = [ \begin{matrix}{C}_{2} & {D}_{2} ]\end{matrix} .$$

In the above matrix expressions, Ã₂=I+T*A₂,\tilde{B}₂=T*B₂,\tilde{F}=T*F, T=0.01 denotes a simulation step size, Nx is the number of state variables, Nu denotes the number of control variables, and Nz denotes the number of disturbance variables. The output matrix of the system at future time steps can be expressed as:

$$Y ( t ) = Ψ ξ ( t \vert t ) + Δ U ( t ) + Ω W ( t \vert t ) .$$

The coefficient matrices in the above equation are obtained by iterative derivation.

Step (3) The optimized objective function is expressed as:

$$J ( ξ ( t ) , u ( t - 1 ) , Δ U ( t ) ) = {\sum }_{i = 1}^{{N}_{p}} {‖ η ( t + i \vert t ) ‖}_{Q}^{2} + {\sum }_{i = 1}^{{N}_{c} - 1} {‖ Δ u ( t + i \vert t ) - ‖}_{R}^{2} + {ρε}^{2} .$$

In the above equation, matrix Q is a weight matrix for the system output, matrix R is a weight matrix for control increments, and ε is a slack factor.

Since the active suspension actuators can only generate limited primary forces, and to prevent frequent collisions with the suspension bump stops, the suspension travel is required to remain within a safe range. In addition, the stator-rotor eccentricity of the in-wheel motors must not exceed its structural limits. Finally, considering vehicle stability, the tire dynamic load is also constrained. Accordingly, the following constraints are imposed on the active suspension system:

$${u}_{min} \leq u \leq {u}_{max} , Δ {u}_{min} \leq Δ u \leq Δ {u}_{max}$$

$$\vert {Z}_{ri} - {Z}_{si} \vert \leq {Zh}_{max} , \vert {Z}_{si} - {Z}_{bi} \vert \leq {Zs}_{max}$$

$${\sum }_{i - 1}^{2} \vert Kti * ( {Z}_{0 i} - {Z}_{n} ) \vert \leq mg$$

Therefore, the optimized problem can ultimately be formulated as the following quadratic programming problem:

$${min}_{Δ U , ε} {\frac{1}{2} [ Δ {U}^{T} , ε ]}^{T} H [ Δ {U}^{T} , ε ] + G [ Δ {U}^{T} , ε ]$$

$$s . t . lb \leq [ Δ U , ε ] \leq ub$$

$$A \_ cons * [ Δ U , ε ] \leq b \_ cons .$$

In the above equation, H, G, lb, ub, A_cons and b_cons are derived from the state-space equations and the constraint conditions.

Considering the integrated strategy between roll stability and ride comfort indices, the final ASS optimized objective function can be expressed as:

$${J}_{all} ( ξ ( t ) , u ( t - 1 ) , Δ U ( t ) ) = {\sum }_{i = 1 , 2} {ε}_{Ji} {J}_{i}$$

$$\{ \begin{matrix}{ε}_{J 1} = 0 , {ε}_{J 2} = 1 & abs ( delta ) < 0.001 \\ {ε}_{J 1} = 1 , {ε}_{J 2} = 1 & abs ( delta ) \geq 0.001\end{matrix} .$$

In the above equation, J₁ and ε_{J1} are the body roll stability objective function and its coordination parameter, respectively, and J₂ and ε_{J2} are the ride comfort objective function and its coordination parameter, respectively.

Step (4) In order to integrate the AFS and ASS systems, the β-\dot{β} phase plane is employed to determine the stability region of the distributed in-wheel motor drive electric vehicle. The stability region Ψ is obtained using the dual-line method, and the boundary of the stability region can be expressed as:

$$ϑ = \vert \dot{β} + {ϑ}_{1} β \vert \leq {ϑ}_{2} .$$

In the above equation, {ϑᵢ}_{i=1, 2} is a stability boundary coefficient.

Meanwhile, the lateral load transfer ratio is introduced to evaluate the roll stability of the distributed in-wheel motor drive electric vehicle, expressed as:

$$LTR = \frac{{F}_{2} + {F}_{4} - {F}_{1} - {F}_{3}}{{F}_{1} + {F}_{2} + {F}_{3} + {F}_{4}} , LTR ∈ [ - 1 , 1 ] .$$

The present disclosure provides the following integrated control strategy based on the vehicle driving condition.
(1) When the distributed in-wheel motor drive electric vehicle travels in a straight line, the AFS controller is inactive, and the ASS controller is operated with ride comfort optimization as control objective, expressed as P₁=0 and P₂=1.
(2) When the distributed in-wheel motor drive electric vehicle is under steering conditions, the AFS controller and ASS controller are activated, where P₁=1 and P₂ is designed based on a loop transfer ratio (LTR) index and stability boundary of the β-\dot{β} phase plane, expressed as:

$${p}_{2} = \{ \begin{matrix}1 ( β , \dot{β} ) ∉ Ψ or LTR >= {LTR}^{*} \\ \frac{ϑ}{{ϑ}_{2}} + {ϑ}^{*} ( β , \dot{β} ) ∈ Ψ and LTR < {LTR}^{*}\end{matrix} .$$

In the above equation, LTR*=0.5 is a stability threshold, and ϑ*=0.4 is a rollover threshold. This equation indicates that when the vehicle state is within the stability region and the LTR is below the rollover threshold, the active suspension partially intervenes; whereas when the vehicle state is outside the stability region or the LTR exceeds the rollover threshold, the active suspension fully intervenes.

The controller designed herein includes an AFS controller, an ASS controller, and an integrated control strategy between the two controllers. The AFS controller is established as an hMPC controller based on the three-dimensional piecewise-affine tire model, with reference to the vehicle's side-slip angle and yaw rate at the center of mass obtained from a two-degree-of-freedom bicycle model, thereby calculating the additional steering angle to ensure vehicle stability. The ASS controller is designed as a multi-constraint-input, multi-constraint-output active suspension system controller based on DMPC, with suspension design objectives including roll stability, ride comfort, as represented by tire dynamic load and vehicle body acceleration, and the eccentricity of the stator and the rotor of the in-wheel motor. The integrated control strategy is designed based on the β-\dot{β} phase plane and the lateral load transfer rate, allowing the two controllers to complement each other and thereby improve the vehicle's dynamic performance.

Based on the above, the method for lateral-vertical integrated control of the distributed in-wheel motor drive electric vehicle provided in this embodiment has the following advantages. (I) A distributed integrated lateral-vertical control method is established, effectively addressing the coupling between different chassis electronic control systems, enhancing vehicle handling stability, and reducing the impact of unbalanced magnetic forces on the suspension and tires. This is specifically reflected in improved roll stability, ride comfort, and in-wheel motor performance. (II) A lateral force-tire slip angle-vertical load-based three-dimensional piecewise-affine tire model is constructed, effectively resolving the difficulty of describing tire nonlinear characteristics under extreme conditions using a linear tire model, thereby improving the control capability of the lateral controller. (III) The integrated strategy of the distributed integrated lateral-vertical control method is designed to comprehensively consider vehicle requirements under different operating conditions. By combining the β-\dot{β} phase plane and the lateral load transfer rate, integrated control of the AFS and ASS is achieved, which can, to some extent, improve vehicle dynamic performance and enhance rollover resistance.

In summary, the method proposed herein includes a vehicle modeling module, three-dimensional piecewise-affine tire model identification, the AFS controller, the ASS controller, and the integrated control strategy. A 14-DOF full-vehicle model is established based on the unbalanced magnetic force model of the in-wheel motor. To improve the modeling accuracy of the lateral controller, a lateral force-tire slip angle-vertical load-based three-dimensional PWA tire model is constructed using the piecewise-affine method, and a mixed logical dynamic (MLD) model is established. Based on this, an hMPC-based active front-wheel steering controller is designed. Considering the effects of unbalanced magnetic forces generated by the in-wheel motors on the suspension system and tires, a DMPC-based active suspension system controller is designed. Furthermore, an integrated strategy for the AFS and ASS is developed based on the front-wheel steering angle, the β-β phase plane, and the lateral load transfer rate. This method addresses the technical problems in the prior art caused by unbalanced magnetic forces on the suspension and tires, as well as the reduced modeling and control accuracy of the lateral controller resulting from linear tire assumptions, thereby improving vehicle handling stability, roll stability and ride comfort.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A method for lateral-vertical integrated control of a distributed in-wheel motor drive electric vehicle, comprising:
constructing a fourteen-degree-of-freedom (14-DOF) full-vehicle model based on an unbalanced magnetic force model of an in-wheel motor;
constructing a lateral force-tire slip angle-vertical load-based three-dimensional piecewise-affine tire model based on the 14-DOF full-vehicle model in combination with a corrected Magic Formula tire model;
based on the lateral force-tire slip angle-vertical load-based three-dimensional piecewise-affine tire model, establishing an active front-wheel steering controller based on hybrid model predictive control; and simultaneously establishing an active suspension system controller based on multi-constraint input and multi-constraint output with roll stability, ride comfort and stator-rotor eccentricity of the in-wheel motor as control objectives; and
establishing an integrated control strategy for the active front-wheel steering controller and the active suspension system controller based on a front-wheel steering angle, a β-\dot{β} phase plane and a lateral load transfer rate, so as to achieve lateral-vertical integrated control of the distributed in-wheel motor drive electric vehicle.

2. The method of claim 1, wherein the unbalanced magnetic force model of the in-wheel motor is constructed with a stator separated from a rotor, and the rotor integrated with a tire;
the 14-DOF full-vehicle model comprises longitudinal motion, lateral motion, yaw motion, pitch motion and roll motion, and vertical motions of sprung mass, stator mass and rotor-tire mass;
wherein differential equations of the longitudinal motion and the lateral motion are respectively expressed as:
$$\begin{matrix}{ma}_{x} = {F}_{x 1} cos ( δ ) + {F}_{x 2} cos ( δ ) + {F}_{x 3} + {F}_{x 4} ; and \\ {ma}_{y} = {F}_{y 1} cos ( δ ) + {F}_{y 2} cos ( δ ) + {F}_{y 3} + {F}_{y 4} ;\end{matrix}$$
wherein m is a vehicle mass, δ is the front-wheel steering angle, aₓ is a longitudinal acceleration, expressed as aₓ=\dot{v}ₓ−v_{y}ω, a_{y} is a lateral acceleration, expressed as a_{y}=\dot{v}_{y}+vₓω, vₓ is a longitudinal velocity, v_{y} is a lateral velocity, Fₓᵢ is a wheel longitudinal force, F_{yi} is a wheel lateral force, and i=1, 2, 3 and 4 representing a left-front tire, a right-front tire, a left-rear tire and a right-rear tire, respectively;
differential equations of the yaw motion, the pitch motion and the roll motion are respectively expressed as:
$${I}_{z} \dot{ω} = a ( {F}_{y 1} + {F}_{y 2} ) cos ( δ ) - b ( {F}_{y 3} + {F}_{y 4} ) + \frac{{B}_{r}}{2} ( {F}_{x 2} cos ( δ ) + {F}_{x 4} ) - \frac{{B}_{f}}{2} ( {F}_{x 1} cos ( δ ) + {F}_{x 3} ) ;$$
$$\begin{matrix}{I}_{y} \ddot{θ} = b ( {F}_{s 3} + {F}_{s 4} ) - a ( {F}_{s 1} + {F}_{s 2} ) + {m}_{b} g ( {h}_{g} - {h}_{s} ) θ ; and \\ {I}_{x} \ddot{ϕ} = \frac{{B}_{f}}{2} ( {F}_{s 1} - {F}_{s 2} ) + \frac{{B}_{r}}{2} ( {F}_{s 3} - {F}_{s 4} ) + {m}_{b} g ( {h}_{g} - {h}_{s} ) ϕ + {m}_{b} {a}_{y} ( {h}_{g} - {h}_{s} ) ;\end{matrix}$$
wherein ω is a yaw rate, a represents a distance between a center of mass and a front axle, b denotes a distance between the center of mass and a rear axle; B_{f} and Bᵣ denote front and rear track widths, respectively; θ is a pitch angle, h_{g} is a height from the center of mass to ground, hₛ is a height from a roll center to the ground, g is a gravitational acceleration, Fₛᵢ is a suspension force, m_{b} is the sprung mass, φ is a roll angle, Iₓ represents a moment of inertia about an x-axis of a coordinate system of the distributed in-wheel motor drive electric vehicle, I_{y} represents a moment of inertia about a y-axis of the coordinate system of the distributed in-wheel motor drive electric vehicle, and I_{z} denotes a moment of inertia about a z-axis of the coordinate system of the distributed in-wheel motor drive electric vehicle; and
the vertical motions of the sprung mass, the stator mass, and the rotor-tire mass are respectively expressed as:
$$\begin{matrix}{m}_{b} {\ddot{Z}}_{b} = {F}_{s 1} + {F}_{s 2} + {F}_{s 3} + {F}_{s 4} ; \\ {m}_{si} {\ddot{Z}}_{i 2} = {K}_{mi} ( {Z}_{i 1} - {Z}_{i 2} ) - {K}_{si} ( {Z}_{i 2} - {Z}_{i 3} ) - {C}_{si} ( {\dot{Z}}_{i 2} - {\dot{Z}}_{i 3} ) - {F}_{si} + {F}_{Ei} ; and \\ {m}_{ri} {\ddot{Z}}_{i 1} = {K}_{ti} ( {Z}_{0 i} - {Z}_{i 1} ) - {K}_{mi} ( {Z}_{i 1} - {Z}_{i 2} ) - {F}_{Ei} ;\end{matrix}$$
wherein, Fₛᵢ=Kₛᵢ(Zᵢ₂−Zᵢ₃)+Cₛᵢ(Żᵢ₂−Żᵢ₃)+Fᵢ, mₛᵢ is the stator mass, mᵣᵢ is the rotor-tire mass, Kₛᵢ is a suspension stiffness coefficient, Cₛᵢ is a suspension damping coefficient, Kₘᵢ is a stiffness coefficient between the stator and the rotor of the in-wheel motor, Kₜᵢ is a tire stiffness coefficient, Zᵢ₁ denotes a vertical displacement of the tire and the rotor, Zᵢ₂ denotes a vertical displacement of the stator, Zᵢ₃ denotes a vertical displacement of the sprung mass, Z₀ᵢ denotes a four-wheel road roughness, Fᵢ denotes a suspension actuating force, and F_{Ei} denotes a vertical unbalanced excitation of the in-wheel motor.

3. The method of claim 1, wherein the corrected Magic Formula tire model is obtained by introducing a road adhesion coefficient into a Magic Formula tire model, and is expressed as:
$${F}_{y} = μ {D}_{y} sin \{ \frac{5 - μ}{4} {C}_{y} arctan [ ( 2 - μ ) {B}_{y} α ( 1 - {E}_{y} ) + {E}_{y} arctan ( ( 2 - μ ) {B}_{y} α ) ] \} ;$$
wherein F_{y} is a wheel lateral force, u is the road adhesion coefficient, a is a tire side-slip angle, B_{y} is a stiffness factor, C_{y} is a shape factor, D_{y} is a crest factor and E_{y} is a curvature factor;
based on a wheel dynamics analysis, the tire side-slip angle is expressed as:
$$\begin{matrix}{α}_{j} = arctan ( \frac{{v}_{y} + a ω}{{v}_{x} ∓ {B}_{f} / 2} ) - δ j = 1 , 2 \\ {α}_{h} = arctan ( \frac{{v}_{y} - b ω}{{v}_{x} ∓ {B}_{r} / 2} ) h = 3 , 4 ;\end{matrix}$$
and
a tire vertical load is expressed as:
$$\begin{matrix}{F}_{zj} = \frac{mgb}{2 L} ∓ \frac{{m}_{b} {a}_{y} {bh}_{g}}{{B}_{f} L} ∓ \frac{{m}_{b} g sin ( ϕ ) {bh}_{g}}{{B}_{f} L} - {F}_{j} - {F}_{Ej} j = 1 , 2 \\ {F}_{zh} = \frac{mga}{2 L} ∓ \frac{{m}_{b} {a}_{y} {ah}_{g}}{{B}_{r} L} ∓ \frac{{m}_{b} g sin ( ϕ ) {ah}_{g}}{{B}_{r} L} - {F}_{h} - {F}_{Eh} h = 3 , 4 ;\end{matrix}$$
wherein F_{z} is the tire vertical load.

4. The method of claim 3, wherein the lateral force-tire slip angle-vertical load-based three-dimensional piecewise-affine tire model is constructed through steps of:
constructing an original dataset Ω based on lateral force-tire slip angle-vertical load data obtained by the corrected Magic Formula tire model; and
performing clustering on the original dataset Ω using an improved K-plane clustering algorithm through steps of:
(1) dividing the original dataset Ω uniformly into n×m sub-datasets Ωⱼ, (j=1 . . . n×m) along an x-axis and a y-axis of three-dimensional scatter plot constructed from extracted data, and fitting a plane parameter of each of the n×m sub-datasets Ωⱼ using a least squares estimation method, expressed as:
$$min {\sum }_{( \tilde{x} ( k ) , \tilde{z} ( k ) ∈ {Ω}_{j} )} {‖ {ε}_{j}^{T} [ \begin{matrix}\tilde{x} ( k ) \\ 1\end{matrix} ] - \tilde{z} ( k ) ‖}^{2} ;$$
wherein εⱼ^{T}=[aⱼ,bⱼ,cⱼ,dⱼ] denotes the plane parameter of each of the n×m sub-datasets Ωⱼ;
assuming that there are p initial clustering planes, randomly selecting one of the p initial clustering planes as a first initial plane, denoted as:
$${M}_{1} = \{ {a}_{1} , {b}_{1} , {c}_{1} , {d}_{1} \} ;$$
(2) performing plane identification on the n×m sub-datasets Ωⱼ, randomly selecting q initial planes from n×m sub-planes, and denoting a parameter mean of determined initial planes {M₁,M₂, . . . , M_{q}} as:
$$\overline{M} = \{ \overline{a} , \overline{b} , \overline{c} , \overline{d} \} ;$$
calculating a difference between a parameter of each of remaining planes among the p initial clustering planes and the parameter mean M̅ by using Euclidean distance, expressed as:
$${D}_{i} ( {Ω}_{j} , {M}_{i} ) = \sqrt{{( \overline{a} - {a}_{i} )}^{2} + {( \overline{b} - {b}_{i} )}^{2} + {( \overline{c} - {c}_{i} )}^{2} + {( \overline{d} - {d}_{i} )}^{2}} ;$$
wherein q denotes the number of the determined initial plane, and q≤p; and
selecting an initial clustering plane with a maximum difference max Dᵢ(Ωⱼ, Mᵢ) as a second initial plane;
(3) repeating step (2) until p initial planes {M₁, M₂, . . . , Mₚ} have been selected to complete initialization of K-plane clustering;
(4) performing clustering on tire data points using the p initial planes, so as to obtain p data subsets {J₁, J₂, . . . , Jₚ}, wherein a data classification rule is expressed as if min (Disᵢ₋ⱼ)⇔(xᵢ,yᵢ,zᵢ)∈Jⱼ;
wherein Disᵢ₋ⱼ denotes a distance between a tire data point (xᵢ,yᵢ,zᵢ) and a j-th initial plane, [aⱼ, bⱼ, cⱼ, dⱼ] denotes a parameter of the j-th initial plane, and the data classification rule is used for assigning the tire data point (xᵢ, yᵢ, zᵢ) into a nearest plane Jⱼ;
(5) performing identification and secondary classification of boundary outliers, wherein when the number of planes for which a distance between the tire data point (xᵢ, yᵢ, zᵢ) and a plane is less than a certain threshold is greater than or equal to 2, the tire data point (xᵢ, yᵢ, zᵢ) is considered as a boundary outlier, and the following condition is satisfied:
$$\begin{matrix}A = [ {Dis}_{i - 1} , {Dis}_{i - 2} , … , {Dis}_{i - p} ] \\ num ( A ( i ) \leq {ε}_{boundary} ) \geq 2 ;\end{matrix}$$
wherein A denotes a distance between the tire data point (xᵢ, yᵢ, zᵢ) and each of planes obtained through re-selection and assignment of data as performed in steps (3) and (4), and ε_{boundary} is a boundary outlier threshold;
classifying the boundary outliers based on minimization of a distance between each of the boundary outliers and a center of each of the p data subsets, so as to obtain a three-dimensional piecewise-affine tire sub-model dataset {PĴ₁, PĴ₂, . . . , PĴₚ};
(6) re-identifying a parameter of each of the p data subsets using a least squares method (LSM), and repeating steps (4)-(5), so as to obtain the three-dimensional piecewise-affine model through multiple iterative cycles of K-plane clustering;
(7) identifying and reclassifying intersecting outliers through steps of:
projecting a data subset PĴₑ containing the intersecting outliers onto the x-axis, the y-axis or a z-axis, so as to convert the data subset PĴₑ into one-dimensional data; performing k-means clustering analysis on the one-dimensional data to obtain a plurality of clustered sub-datasets, and identifying the intersecting outliers based on proportion of each of the plurality of clustered sub-datasets within the data subset PĴₑ, wherein the proportion of each of the plurality of clustered sub-datasets is expressed as:
$$\frac{size ( P {\hat{J}}_{e \vert j} )}{size ( P {\hat{J}}_{e} )} \leq {ξ}_{cut} ;$$
wherein PĴ_{e|j} is a sub-dataset obtained by k-means clustering, e=1, 2, . . . , p and j denotes the number of clusters generated by the k-means clustering, which is determined by distribution of PĴₑ, size (*) denotes the number of data points in the data subset PĴₑ, and ξ_{cut} is a segmentation outlier threshold;
classifying the intersecting outliers based on minimization of a distance between each of the intersecting outliers and the center of each of the p data subsets, so as to obtain a three-dimensional piecewise-affine tire sub-model {P\tilde{J}₁, P\tilde{J}₂, . . . , P\tilde{J}ₚ}, and re-identifying plane parameters of the three-dimensional piecewise-affine tire sub-model {P\tilde{J}₁, P\tilde{J}₂, . . . , P\tilde{J}ₚ} using the LSM; and
(8) estimating a boundary coefficient matrix of the three-dimensional piecewise-affine tire sub-model {P\tilde{J}₁, P\tilde{J}₂, . . . , P\tilde{J}ₚ} using a support vector machine;
wherein the three-dimensional piecewise-affine tire model is expressed as:
$${F}_{y} = {θ}_{i - 1} α + {θ}_{i - 2} {F}_{z} + {θ}_{i - 3} , i = ( 1 , 2 , … , p ) ;$$
wherein θᵢ₋₁, θᵢ₋₂ and θᵢ₋₃ denotes parameters of the three-dimensional piecewise-affine tire model.

5. The method of claim 1, wherein the step of based on the three-dimensional piecewise-affine tire model, establishing the active front-wheel steering controller based on hybrid model predictive control comprises:
simplifying a lateral dynamics model based on the 14-DOF full-vehicle model to obtain an error state-space equation;
introducing auxiliary discrete variables and auxiliary continuous variables to transform the error state-space equation to a mixed logical dynamical predictive model; and
designing an objective function based on minimizing errors of a yaw rate and a center-of-mass side-slip angle, and solving a quadratic programming problem, so as to establish the active front-wheel steering controller based on the hybrid model predictive control.

6. The method of claim 1, wherein the step of establishing the active suspension system controller based on multi-constraint input and multi-constraint output comprises:
simplifying the 14-DOF full-vehicle model to obtain a half-vehicle suspension model; and
solving a quadratic programming problem based on the half-vehicle suspension model using roll stability, ride comfort and stator-rotor eccentricity of the in-wheel motor as control objectives, so as to obtain objective functions and coordination parameters corresponding to roll stability and ride comfort, so as to establish the active suspension system controller based on multi-constraint input and multi-constraint output.

7. The method of claim 1, wherein the step of establishing the integrated control strategy for the active front-wheel steering controller and the active suspension system controller based on the front-wheel steering angle, the β-\dot{β} phase plane and the lateral load transfer rate comprises:
(1) when the distributed in-wheel motor drive electric vehicle travels in a straight line, setting the active front-wheel steering controller in an inactive state, and operating the active suspension system controller with ride comfort optimization as control objective, expressed as P₁=0 and P₂=1;
(2) when the distributed in-wheel motor drive electric vehicle is under steering conditions, activating the active front-wheel steering controller and the active suspension system controller, wherein P₁=1, and P₂ is designed based on a loop transfer ratio (LTR) index and stability boundary of the β-\dot{β} phase plane, expressed as:
$${p}_{2} = \{ \begin{matrix}1 ( β , \dot{β} ) ∉ Ψ or LTR >= {LTR}^{*} \\ \frac{ϑ}{{ϑ}_{2}} + {ϑ}^{*} ( β , \dot{β} ) ∈ Ψ and LTR < {LTR}^{*}\end{matrix} ;$$
wherein LTR* is a stability threshold, and ϑ* is a rollover threshold.

8. A system for implementing the method of claim 1, comprising:
a first model construction module;
a second model construction module;
a controller establishment module; and
an integrated control module;
wherein the first model construction module is configured to construct the 14-DOF full-vehicle model based on the unbalanced magnetic force model of the in-wheel motor;
the second model construction module is configured to construct the lateral force-tire slip angle-vertical load-based three-dimensional piecewise-affine tire model based on the 14-DOF full-vehicle model in combination with the corrected Magic Formula tire model;
the controller establishment module is configured to establish the active front-wheel steering controller based on hybrid model predictive control using the three-dimensional piecewise-affine tire model, and simultaneously establish the active suspension system controller based on multi-constraint input and multi-constraint output with roll stability, ride comfort, and stator-rotor eccentricity of the in-wheel motor as the control objectives; and
the integrated control module is configured to establish an integrated control strategy for the active front-wheel steering controller and the active suspension system controller based on the front-wheel steering angle, the β-\dot{β} phase plane and the lateral load transfer rate, so as to achieve lateral-vertical integrated control of the distributed in-wheel motor drive electric vehicle.

9. A device, comprising:
a memory; and
a processor;
wherein the memory is configured for storing a computer program; and
the processor is configured for executing the computer program to implement the method of claim 1.

10. A computer-readable storage medium, wherein the computer-readable storage medium is configured for storing a computer program; and the computer program is configured to be executed by a processor to implement the method of claim 1.
